(19) United States
(12) Patent Application Publication
(10) Pub. No.: US 2025/0335790 A1
(43) Pub. Date: Oct. 30, 2025

(54) CONFIGURATION OF A DIGITAL PLATFORM BASED ON MODELED USER BEHAVIOR

(71) Applicant: Dell Products L.P., Round Rock, TX (US)

(72) Inventors: Shannon Rogers, Austin, TX (US); Annamarie Huttunen, Littleton, CO (US); Jordan E. Lord, Austin, TX (US); Melissa Duenas Fisher, Leander, TX (US)

(21) Appl. No.: 18/650,537

(22) Filed: Apr. 30, 2024

(51) Int. Cl. G06N 5/022

(52) U.S. Cl. CPC G06N 5/022

(57) ABSTRACT

An apparatus includes at least one processing device configured to monitor interaction of users with a digital platform, to determine associations between the monitored interaction and a set of constructs, and to generate a model of user behavior associated with the digital platform, the generated model specifying interrelationships of at least particular constructs in the set of constructs with one another and an output behavioral metric. The at least one processing device is also configured to predict, utilizing the generated model and the determined associations between the monitored interaction and the set of constructs, effects of one or more modifications to a configuration of the digital platform on the output behavioral metric. The at least one processing device is further configured to implement at least one of the one or more modifications to the configuration of the digital platform based at least in part on the predicted effects.

### BACKGROUND

As the value and use of information continues to increase, individuals and businesses seek additional ways to process and store information. Information processing systems may be used to process, compile, store and communicate various types of information. Because technology and information processing needs and requirements vary between different users or applications, information processing systems may also vary (e.g., in what information is processed, how the information is processed, how much information is processed, stored, or communicated, how quickly and efficiently the information may be processed, stored, or communicated, etc.). Information processing systems may be configured as general purpose, or as special purpose configured for one or more specific users or use cases (e.g., financial transaction processing, airline reservations, enterprise data storage, global communications, etc.). Information processing systems may include a variety of hardware and software components that may be configured to process, store, and communicate information and may include one or more computer systems, data storage systems, and networking systems.

### SUMMARY

Illustrative embodiments of the present disclosure provide techniques for configuration of a digital platform based on modeled user behavior.

In one embodiment, an apparatus comprises a storage system comprising a plurality of storage devices and at least one processing device comprising a processor coupled to a memory. The at least one processing device is configured to monitor interaction of a plurality of users with a digital platform, to determine associations between the monitored interaction of the plurality of users with the digital platform and a set of constructs, and to generate a model of user behavior associated with the digital platform, the generated model specifying interrelationships of the set of constructs with one another and an output behavioral metric. The at least one processing device is also configured to predict, utilizing the generated model and the determined associations between the monitored interaction of the plurality of users and the set of constructs, effects of one or more modifications to a configuration of the digital platform on the output behavioral metric. The at least one processing device is further configured to implement at least one of the one or more modifications to the configuration of the digital platform based at least in part on the predicted effects of the one or more modifications to the configuration of the digital platform on the output behavioral metric.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for configuration of a digital platform based on modeled user behavior in an illustrative embodiment.

FIG. 2 is a flow diagram of an exemplary process for configuration of a digital platform based on modeled user behavior in an illustrative embodiment.

FIG. 3 shows a graph of hypothesized relationships among constructs for a behavioral analysis model in an illustrative embodiment.

FIGS. 4A-4H show a table of items utilized for validating a behavioral analysis model in an illustrative embodiment.

FIG. 5 shows a table of model fit statistics interpretation for validating a behavioral analysis model in an illustrative embodiment.

FIG. 6 shows a graph of validated relationships among constructs for a behavioral analysis model in an illustrative embodiment.

FIG. 7 shows a chart characterizing output of a behavioral analysis model for different constructs for different types of users in an illustrative embodiment.

FIG. 8 shows another chart characterizing output of a behavioral analysis model for different constructs for different types of users in an illustrative embodiment.

FIG. 9 shows a chart of different levels of determinants for individual human behavior and decision-making in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

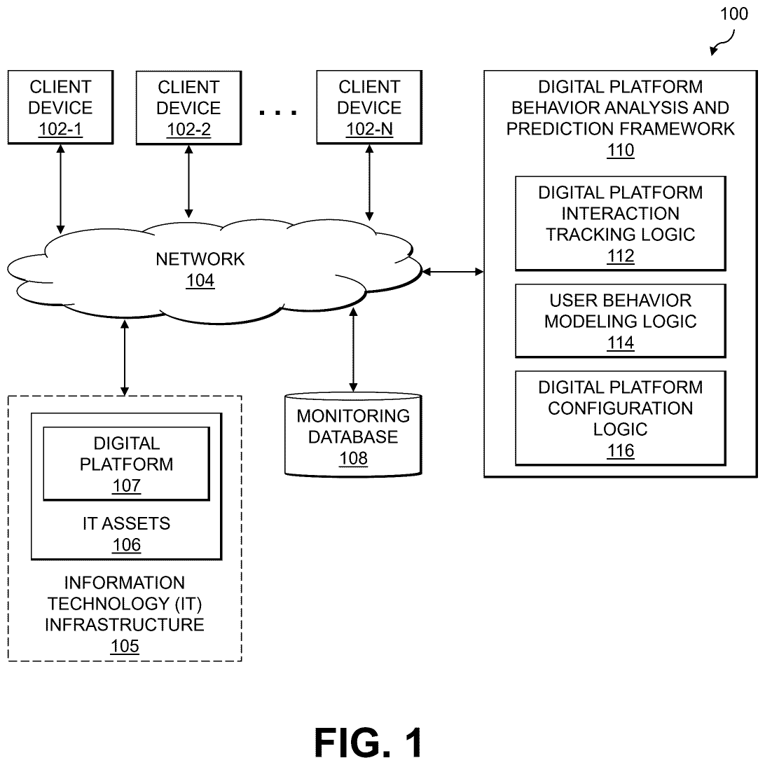

FIG. 1 shows an information processing system 100 configured in accordance with an illustrative embodiment. The information processing system 100 is assumed to be built on at least one processing platform and provides functionality for configuration of a digital platform based on modeled user behavior. The information processing system 100 includes a set of client devices 102-1, 102-2, . . . 102-N (collectively, client devices 102) which are coupled to a network 104 used to access a digital platform 107 that runs on one or more information technology (IT) assets 106 of an IT infrastructure 105. The digital platform 107 may comprise, for example, a website and/or one or more applications or other interfaces that are accessed by users of the client devices 102 for interacting with a particular enterprise, organization or other entity operating the digital platform 107 (e.g., an e-commerce platform for managing orders and servicing of products and services offered by the enterprise, organization or other entity operating the digital platform 107). The digital platform 107 may rely on various dependent systems (e.g., backend applications running on the IT assets 106 of the IT infrastructure 105) for rendering a user interface (UI) that provides various functionality for performing self-servicing actions related to products and services offered by the enterprise, organization or other entity that operates the digital platform 107. The IT assets 106 of the IT infrastructure 105 may include physical and virtual computing resources. Also coupled to the network 104 is a monitoring database 108 and a digital platform behavior analysis and prediction framework 110.

The digital platform behavior analysis and prediction framework 110 is configured to analyze behavior of users (e.g., of the client devices 102) on the digital platform 107 so as to model user behavior (e.g., user “loyalty” to an enterprise, organization or other entity operating the digital platform 107). The digital platform behavior analysis and prediction framework 110 is therefore able to provide a solution for analyzing and quantifying latent drivers of user loyalty to the enterprise, organization or other entity operating the digital platform 107, and provides a flexible, scalable, validated scaffolding onto which the enterprise, organization or other entity operating the digital platform 107 is able to automate measures, expand its observational data surveillance, link experiential value to financial profitability or other metrics, identify at-risk users, prioritize online use case opportunities and, ultimately, predict individual user behavior on the digital platform 107. To do so, the digital platform behavior analysis and prediction framework 110 implements digital platform interaction tracking logic 112, user behavior modeling logic 114, and digital platform configuration logic 116. The digital platform interaction tracking logic 112 is configured to track actions of users (e.g., of the client devices 102) on the digital platform 107, and when available to correlate such actions with survey data or other feedback provided by the users relating to their experiences on the digital platform 107. The user behavior modeling logic 114 is configured to utilize such tracked actions to build a model of user behavior (e.g., of latent constructs which are determined to be antecedents to an outcome of interest, such as behavioral loyalty to the enterprise, organization or other entity operating the digital platform 107). The digital platform configuration logic 116 is configured to utilize the generated model to predict individual user behavior using different potential configurations or changes to the configuration of the digital platform 107. Based on such predictions, the digital platform configuration logic 116 can implement particular ones of the potential configurations or changes to the configuration of the digital platform 107. The digital platform behavior analysis and prediction framework 110 may interact with or communicate with the client devices 102, the digital platform 107 and/or the monitoring database 108 through various host agents running on such components, or via other communication channels.

The client devices 102 may comprise, for example, physical computing devices such as mobile telephones, laptop computers, tablet computers, desktop computers, Internet of Things (IoT) devices, or other types of devices. Such devices are examples of what are more generally referred to herein as “processing devices.” Some of these processing devices are also generally referred to herein as “computers.” The client devices 102 in some cases may also or alternatively comprise virtualized computing resources, such as virtual machines (VMs), software containers, etc.

The client devices 102 may in some embodiments comprise respective computers associated with different companies, enterprises, organizations or other entities. In addition, at least portions of the system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be used, including a wide area network (WAN), a local area network (LAN), a satellite network, a telephone or cable network, a cellular network, a wireless network such as a WiFi or WiMAX network, or various portions or combinations of these and other types of networks.

The digital platform 107 running on IT assets 106 of the IT infrastructure 105 may be associated with or operated by one or more enterprises, organizations or other entities. The IT assets 106 and the IT infrastructure 105 on which the digital platform 107 runs may therefore be referred to as an enterprise system. As used herein, the term “enterprise system” is intended to be construed broadly to include any group of systems or other computing devices. In some embodiments, an enterprise system includes cloud infrastructure comprising one or more clouds (e.g., one or more public clouds, one or more private clouds, one or more hybrid clouds, combinations thereof, etc.). The cloud infrastructure may also host at least a portion of the client devices 102. A given enterprise system may host assets that are associated with multiple enterprises (e.g., two or more different businesses, entities or other organizations). For example, in some cases the IT infrastructure 105 may host multiple different digital platforms associated with different enterprises (e.g., different vendors) which offer their products and services to users of the client devices 102. Each of such multiple digital platforms may utilize the digital platform behavior analysis and prediction framework 110 (or another instance thereof) for tracking and modeling user behavior, and for configuring the digital platforms utilizing user behavior predictions produced using user behavior models. The monitoring database 108 and/or the digital platform behavior analysis and prediction framework 110, although shown in FIG. 1 as being implemented external to the IT infrastructure 105, may in other embodiments be at least partially implemented using IT assets of the IT infrastructure 105 (e.g., potentially the same IT assets 106 on which the digital platform 107 runs).

The monitoring database 108, as discussed above, is configured to store and record various information that is used by the digital platform behavior analysis and prediction framework 110 in tracking user interaction with the digital platform 107, generating a model of user behavior relating to the digital platform 107, and for configuring the digital platform 107 based on user behavior predictions. In some embodiments, the monitoring database 108 stores information related to user behavior on the digital platform 107, and can include information such as survey response or other feedback related to the experience of different users on the digital platform 107, observed actions of users on the digital platform 107, etc. The monitoring database 108 in some embodiments is implemented using one or more storage systems or devices associated with the digital platform behavior analysis and prediction framework 110. In some embodiments, one or more of the storage systems utilized to implement the monitoring database 108 comprises a scale-out all-flash content addressable storage array or other type of storage array. The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the client devices 102, the digital platform 107, the monitoring database 108 and the digital platform behavior analysis and prediction framework 110, as well as to support communication therebetween and with other related systems and devices not explicitly shown.

Although shown in the FIG. 1 embodiment as being separate from the client devices 102 and the digital platform 107 (e.g., as a stand-alone server, set of servers or other type of system coupled via the network 104 to the client devices 102 and the digital platform 107), the digital platform behavior analysis and prediction framework 110 or at least portions thereof (e.g., one or more of the digital platform interaction tracking logic 112, the user behavior modeling logic 114 and the digital platform configuration logic 116) may in other embodiments be implemented at least in part internally to one or more of the client devices 102 and/or the IT infrastructure 105 (e.g., potentially on the same IT assets 106 on which the digital platform 107 runs). In some embodiments, the digital platform behavior analysis and prediction framework 110 is implemented as a service that the digital platform 107 (and potentially other distinct digital platforms) and/or the client devices 102 subscribe to.

The client devices 102, the digital platform 107, the IT assets 106, the monitoring database 108 and the digital platform behavior analysis and prediction framework 110 in the FIG. 1 embodiment are assumed to be implemented using at least one processing device. Each such processing device generally comprises at least one processor and an associated memory, and implements at least a portion of the functionality of such elements, such as one or more of the digital platform interaction tracking logic 112, the user behavior modeling logic 114 and the digital platform configuration logic 116 of the digital platform behavior analysis and prediction framework 110.

It is to be appreciated that the particular arrangement of the client devices 102, the IT assets 106, the digital platform 107, the monitoring database 108 and the digital platform behavior analysis and prediction framework 110 illustrated in the FIG. 1 embodiment is presented by way of example only, and alternative arrangements can be used in other embodiments. As discussed above, for example, the digital platform behavior analysis and prediction framework 110 may in some cases be implemented at least in part internal to one or more of the client devices 102 and/or the IT infrastructure 105. At least portions of the digital platform interaction tracking logic 112, the user behavior modeling logic 114 and the digital platform configuration logic 116 may be implemented at least in part in the form of software that is stored in memory and executed by a processor.

It is to be understood that the particular set of elements shown in FIG. 1 for configuration of the digital platform 107 based on modeled user behavior is presented by way of illustrative example only, and in other embodiments additional or alternative elements may be used. Thus, another embodiment may include additional or alternative systems, devices and other network entities, as well as different arrangements of modules, logic and other components.

The client devices 102, the IT assets 106, the digital platform 107, the monitoring database 108 and the digital platform behavior analysis and prediction framework 110, as described above and in further detail below, may be part of cloud infrastructure.

The client devices 102, the IT assets 106, the digital platform 107, the monitoring database 108 and the digital platform behavior analysis and prediction framework 110, and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources. The client devices 102, the IT assets 106, the digital platform 107, the monitoring database 108 and the digital platform behavior analysis and prediction framework 110, or components thereof, may be implemented on respective distinct processing platforms, although numerous other arrangements are possible. For example, in some embodiments at least portions of client devices 102, the IT assets 106, the digital platform 107, the monitoring database 108 and the digital platform behavior analysis and prediction framework 110, or components thereof, are implemented on the same processing platform.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for client devices 102, the IT assets 106, the digital platform 107, the monitoring database 108 and the digital platform behavior analysis and prediction framework 110, or portions or components thereof, to reside in different data centers. Numerous other distributed implementations are possible.

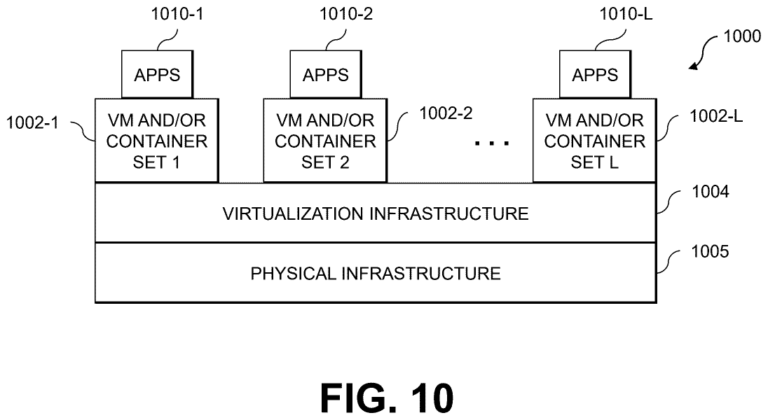

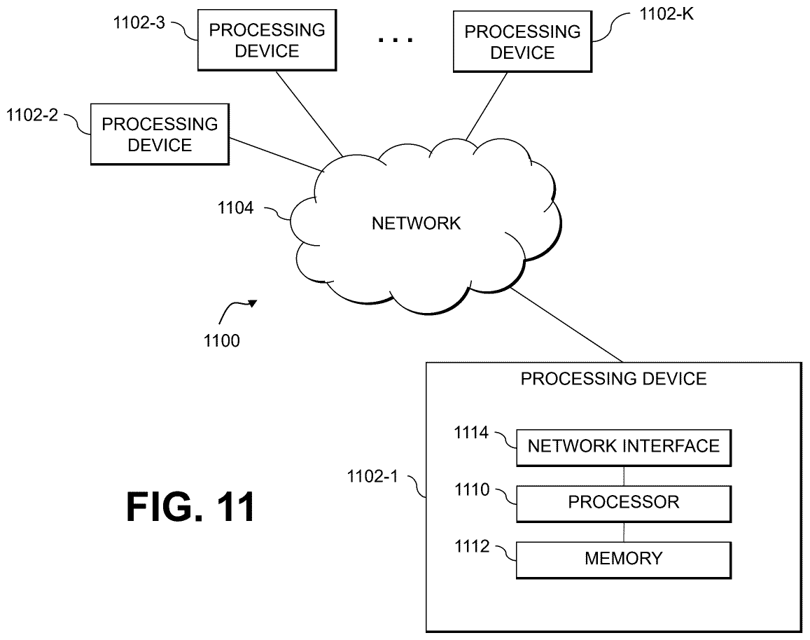

Additional examples of processing platforms utilized to implement client devices 102, the IT assets 106, the digital platform 107, the monitoring database 108 and the digital platform behavior analysis and prediction framework 110, and other components of the system 100 in illustrative embodiments will be described in more detail below in conjunction with FIGS. 10 and 11.

It is to be appreciated that these and other features of illustrative embodiments are presented by way of example only, and should not be construed as limiting in any way.

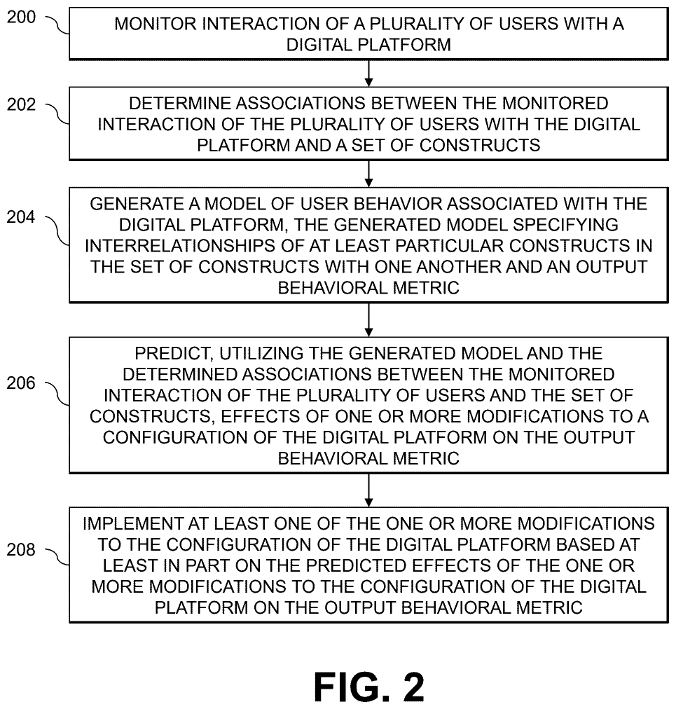

An exemplary process for configuration of a digital platform based on modeled user behavior will now be described in more detail with reference to the flow diagram of FIG. 2. It is to be understood that this particular process is only an example, and that additional or alternative processes for configuration of a digital platform based on modeled user behavior may be used in other embodiments.

In this embodiment, the process includes steps 200 through 208. These steps are assumed to be performed by the digital platform behavior analysis and prediction framework 110 utilizing the digital platform interaction tracking logic 112, the user behavior modeling logic 114 and the digital platform configuration logic 116. The process begins with step 200, monitoring interaction of a plurality of users (e.g., users of client devices 102) with a digital platform (e.g., digital platform 107). The digital platform may comprise at least one of a website and a web-based interactive application operated by a given vendor of IT assets.

In step 202, associations between the monitored interaction of the plurality of users with the digital platform and a set of constructs (e.g., latent constructs) are determined. Step 202 may include collecting a set of explicit evaluations of a plurality of latent constructs for at least a subset of the plurality of users, and correlating (i) the monitored interaction of the subset of the plurality of users with the digital platform and (ii) the collected set of explicit evaluations of the plurality of latent constructs.

In step 204, a model of user behavior associated with the digital platform is generated. The generated model specifies interrelationships of at least particular ones of the constructs in the set of constructs with one another and an output behavioral metric. The output behavioral metric may characterize behavioral loyalty to an entity operating the digital platform. Step 204 may comprise utilizing Confirmatory Factor Analysis (CFA) to determine measurement quality of respective ones of a plurality of latent constructs for the output behavioral metric, and selecting the set of constructs from the plurality of latent constructs based at least in part on the determined measurement quality. Step 204 may also or alternatively comprise determining interrelationships and covariation among a plurality of latent constructs and the output behavioral metric, and evaluating model fit statistics associated with inclusion of respective ones of the plurality of latent constructs in the generated model and/or inclusion and removal of paths between different ones of the plurality of latent constructs in the generated model. Step 204 may further or alternatively comprise utilizing Structural Equation Models (SEM) to determine the interrelationships of at least particular ones of the constructs in the set of constructs with one another and the output behavioral metric. Determining the interrelationships may comprise testing linkages and directionality of paths interconnecting the constructs with one another and the output behavioral metric in a graph structure.

In step 206, the generated model and the determined associations between the monitored interaction of the plurality of users and the set of constructs are utilized to predict effects of one or more modifications to a configuration of the digital platform on the output behavioral metric. The one or more modifications to the configuration of the digital platform comprises prioritizations of one or more aspects of a digital experience to deliver to different subsets of the plurality of users of the digital platform.

In step 208, at least one of the one or more modifications to the configuration of the digital platform is implemented based at least in part on the predicted effects of the one or more modifications to the configuration of the digital platform on the output behavioral metric.

In some embodiments, step 204 includes generating two or more versions of the generated model associated with different subsets of the plurality of users, wherein a first one of the two or more versions of the generated model associated with a first subset of the plurality of users has a first set of weightings for the interrelationships of at least particular ones of the constructs in the set of constructs with one another and the output behavioral metric, and wherein a second one of the two or more versions of the generated model associated with a second subset of the plurality of users has a second set of weightings for the interrelationships of at least particular ones of the constructs in the set of constructs with one another and the output behavioral metric, the second set of weighting being different than the first set of weightings. The first subset of the plurality of users and the second subset of the plurality of users may be associated with at least one of different types of users and different age groups. Step 206 may include predicting a first set of effects of the one or more modifications to the configuration of the digital platform on the output behavioral metric for the first subset of the plurality of users utilizing the first version of the generated model, and predicting a second set of effects of the one or more modifications to the configuration of the digital platform on the output behavioral metric for the second subset of the plurality of users utilizing the second version of the generated model. Step 208 may include implementing at least a first one of the one or more modifications to the configuration of the digital platform for the first subset of the plurality of users based at least in part on the predicted first set of effects, and implementing at least a second one of the one or more modifications to the configuration of the digital platform for the second subset of the plurality of users based at least in part on the predicted second set of effects.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for configuration of digital platforms based on modeled user behavior, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Enterprises may benefit from a holistic measurement for customer or other user loyalty, where the holistic measurement can be sustainably, universally and/or individually calculated. In conventional approaches, enterprises typically either rely on a single metric (e.g., financial profitability) for a user (and most often only so for large enterprise account-level users) as a proxy for determining the user's loyalty (e.g., cumulative lifetime value), or rely on a few cross-sectional metrics that are used to convey user loyalty (e.g., Customer Satisfaction (CSAT), Net Promoter Score (NPS), etc.). Such measures proffer only a partial understanding of user value, and do not allow for the causal analysis of experiential value to a user's decision to become or remain loyal. To calculate a truly holistic, comprehensive measure of loyalty drivers and loyal behavior that can be mapped from the initiatives that an enterprise is taking to repeat purchases or other desirable user behavior on a digital platform, a more bespoke, complex approach is needed.

The technical solutions described herein provide the digital platform behavior analysis and prediction framework 110, which may also be referred to as a user loyalty analysis and behavioral prediction framework, which provides a theoretical and statistical method for analyzing and quantifying latent drivers of user behavior (e.g., user loyalty to a digital platform such as digital platform 107, or to an enterprise, organization or other entity operating the digital platform 107). The digital platform behavior analysis and prediction framework 110 may be customized for a particular enterprise, organization or other entity that is operating a specific digital platform (e.g., digital platform 107). Furthermore, the digital platform behavior analysis and prediction framework 110 acts as a flexible, scalable, validated scaffolding onto which an enterprise, organization or other entity operating a digital platform intends to automate measures, expand its observational data surveillance, link experiential value to financial profitability or other metrics, identify at-risk users, prioritize online business case opportunities in a digital platform, and, ultimately, predict individual user behavior as it is related to a digital platform. The technical solutions described herein provide a novel approach for user loyalty measurement which expands well beyond conventional approaches which rely on user experiential metrics such as CSAT, Customer Effort (CES), Ease of Use (EOU), and Customer's NPS (CNPS).

Off-the-shelf or conventional industry measures of user loyalty are insufficiently specific at the individual user level. Industry-available measures must be ambiguous enough to be implemented, and sometimes validated, across a wide array of industries (e.g., health care, technology commerce, etc.). This flexibility neither models the complex nature of the individual psychological and neuro-cognitive process of preference formation necessary in deciding to become a loyal user, nor appropriately captures the specifics of the population of which the measure is intended to measure. Further, the data necessary to determine some measures are not prescribed-for in the initial sizing phases of measure-shopping, so various deep learning claims made from off-the-shelf user loyalty metrics become impossible once data requirements are made known. Ultimately, additional deployments are necessary to help fill in the gaps between perception measures like satisfaction or net promotion.

Conventional approaches thus suffer from various technical challenges, including the use of one-size-fits-all measures. Individual context matters, such that one-size-fits-all measures are not optimal. Traditional user loyalty frameworks have either been validated in small sub-populations or broad swaths of industry. Both approaches are problematic because they are either too narrowly evaluative or too broadly flexible. The individual socio-determinants or behavior and decision-making are not considered, nor is a specific enterprise context quantified for inclusion into the model. As a result, user loyalty measurement in such conventional approaches is confounded at the individual level and beyond, which will result in poor statistical model fit and inability to explain variability (e.g., a mediocre to poor measure of user loyalty and its drivers).

In addition, conventional approaches suffer from the problem of a lack of causal relationship between experiential drivers and user behavior. Survey data is traditionally relied upon to create and measure user loyalty. Thus, there is no verifiable outcome to the actual behavior that the survey is intended to measure. NPS and CSAT are rarely, if ever, linked to individual or account-level loyal behaviors because of the data complexity required to do so. As such, it is not possible to evaluate the statistical relationships between supposed loyal behavior drivers and actual loyal behaviors as either financial or other behavioral outcomes.

Further, conventional approaches do not have the ability to explore non-transactional behavioral loyalty. Due to the data required to analyze loyalty antecedents and loyal behavior for the same individuals over time, loyalty drivers' impact on non-transactional loyal behavior have not been sufficiently explored, for online or offline behaviors (e.g., of an enterprise, organization or other entity's digital platform, such as a website or other user-facing online interface). This is problematic since it is thought that most of the psychological determination to become or remain a loyal user occurs after a transaction, and is important as various industries transition to as-a-service and other online subscription offerings. Repeat tasks, visits, and account and service management are all loyal behaviors and important to understand in relation to the online experience.

Still further, conventional approaches are unadaptable and unscalable. Current and traditional measures of user experience and user loyalty are static and rationally so, as they are used for industry-wide comparisons, trending and benchmarking. These static measures, however, cannot be adapted to ingest new experiential offerings (e.g., design changes, feature enhancements, site speed/stability innovations of a digital platform, etc.) or newly automated measures (e.g., non-survey inputs). As data around experience becomes more numerous, and as analytics becomes more automated and “deep” via neural networks and other machine learning, a more adaptable loyalty measurement framework is necessary.

Conventional approaches also suffer from technical challenges related to generalizability and external validity (e.g., as survey participation is not required). An enterprise, organization or other entity may make great strides in increasing its surveillance capacity from CSAT to more recent implementations of EOU surveys to understand the user experience on a digital platform from a quantitative standpoint. However, even with such efforts, only a limited subset of the user population is represented in current experiential metrics. To greater increase the generalizability of the user population in an enterprise's analytics, it is necessary to ween off of strict survey reliance but to do so with statistical certainty through the form of convergent validity. When implicit (e.g., observed) and explicit (e.g., stated) feedback converge statistically, there is more confidence that the observation can be used as a proxy for the latent relationship. This novel approach, which may be leveraged in the technical solutions described herein, can accommodate the ingestion of manifest (e.g., observed) non-survey variables, thereby increasing the representation of the user base and the inferences that can be made from the data that is available.

Furthermore, conventional approaches suffer from a lack of predictability. The ultimate goal of most inferential statistics around user behavior is behavior prediction. Measuring the latent drivers of user loyalty enables the statistical prediction of user behavior given the set of measurable antecedents. Bayesian Neural Networks (BNNs), for example, are one way to condition on one or more interrelated observed (e.g., measured) properties to predict a downstream outcome. The technical solutions described herein can leverage these and other statistical methods of prediction within the digital platform behavior analysis and prediction framework 110.

In some embodiments, the digital platform behavior analysis and prediction framework 110 is configured to generate a model with various constructs and items panning each construct's underlying dimension. Qualitative and quantitative data from a customer sentiment organization, including CSAT and Voice of Customer as a Service (VoCaaS) EOU survey data, is also used to adapt the wording and existing scale items to the current enterprise, organization or other entity's user context. The novel latent constructs included in the model generated by the digital platform behavior analysis and prediction framework 110 may include, for example, customization/personalization, design, ease & effectiveness, quality, empathy, agency/empowerment, perceived value, sentiment, trust, brand connectedness and attitudinal loyalty.

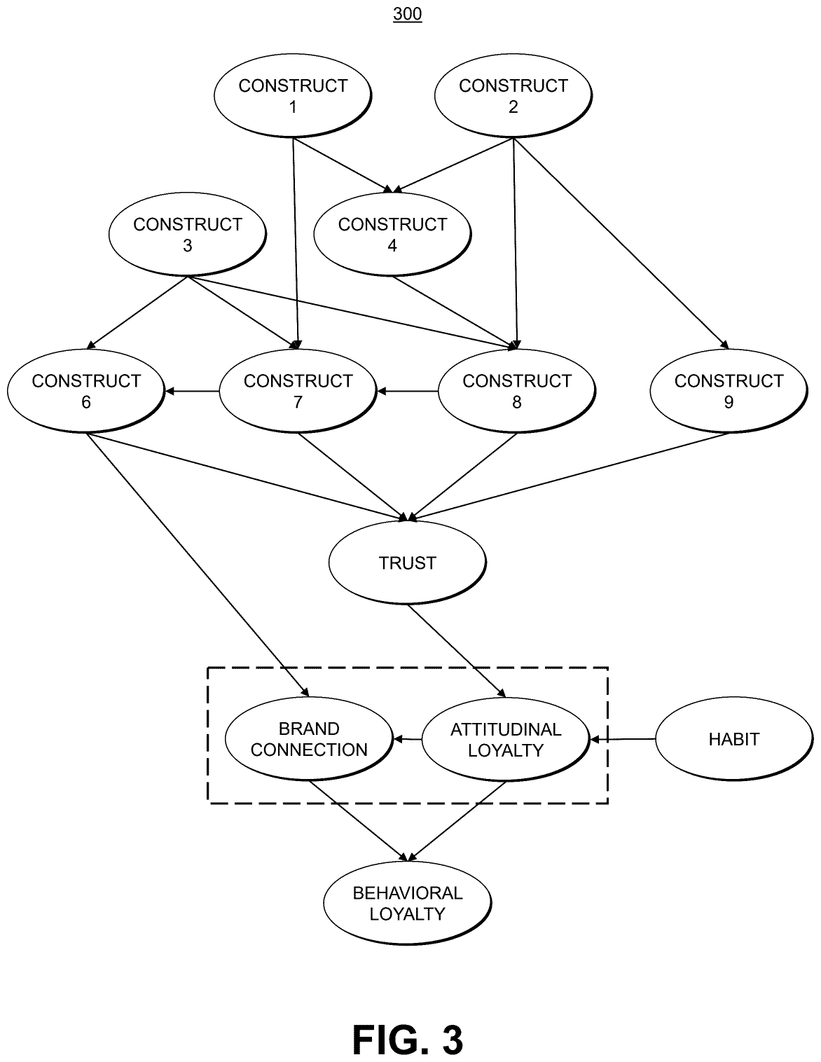

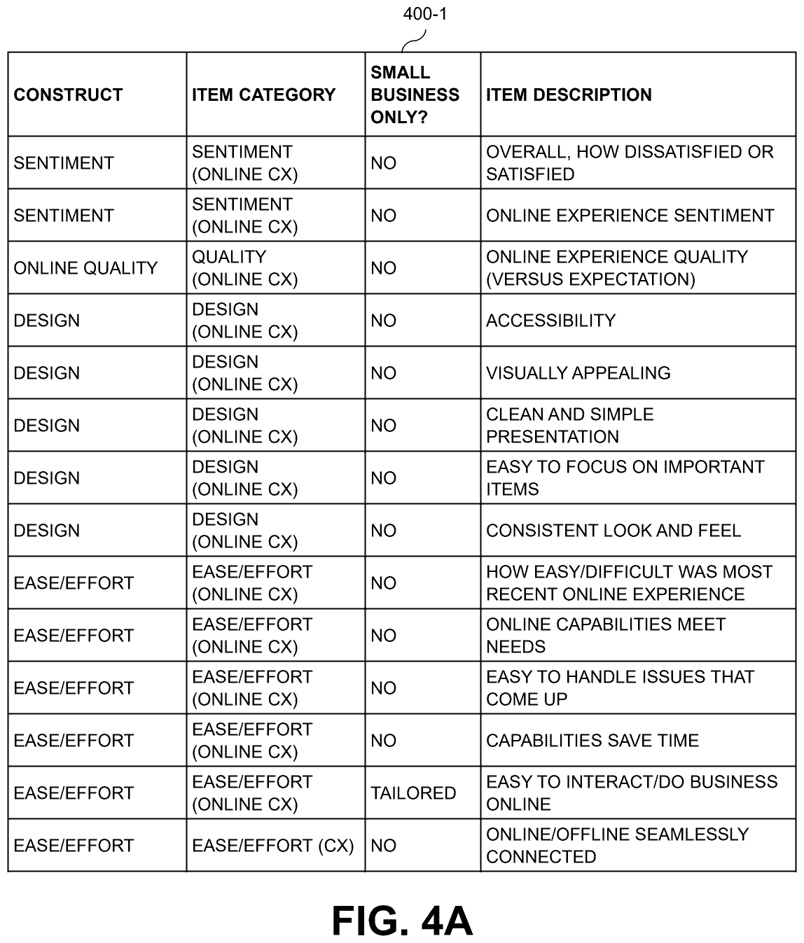

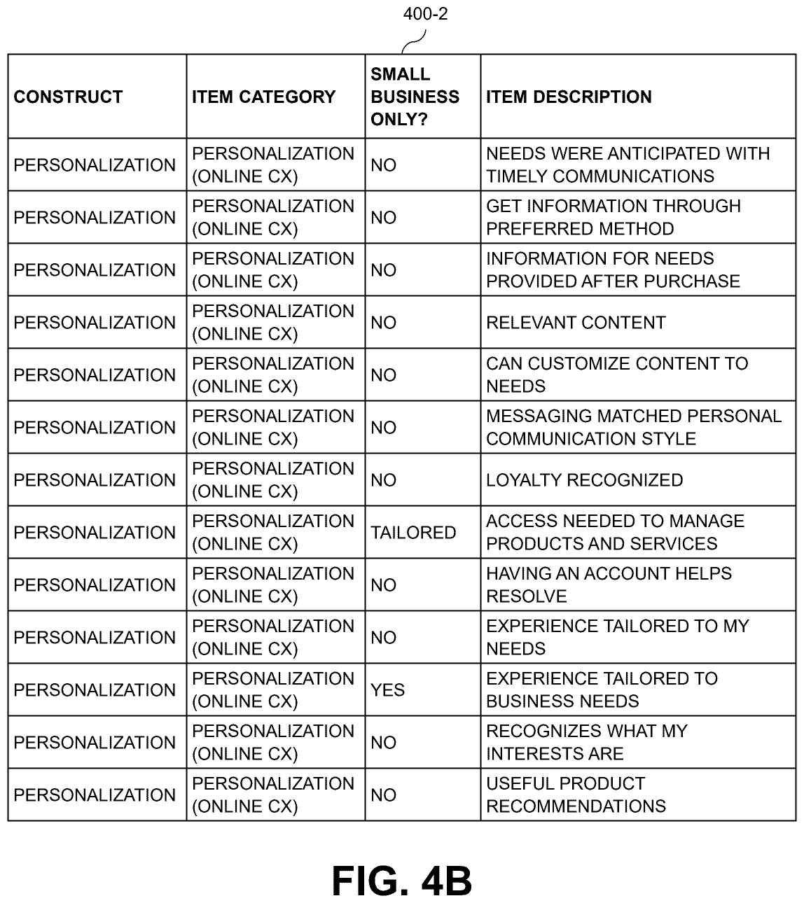

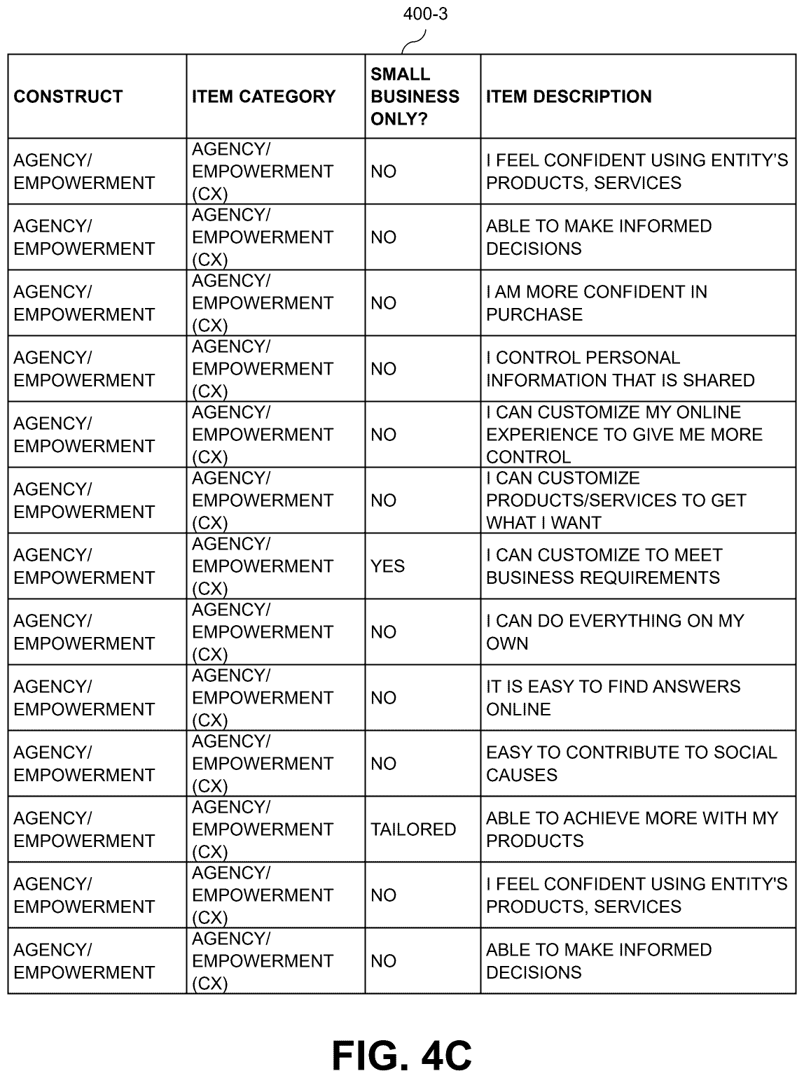

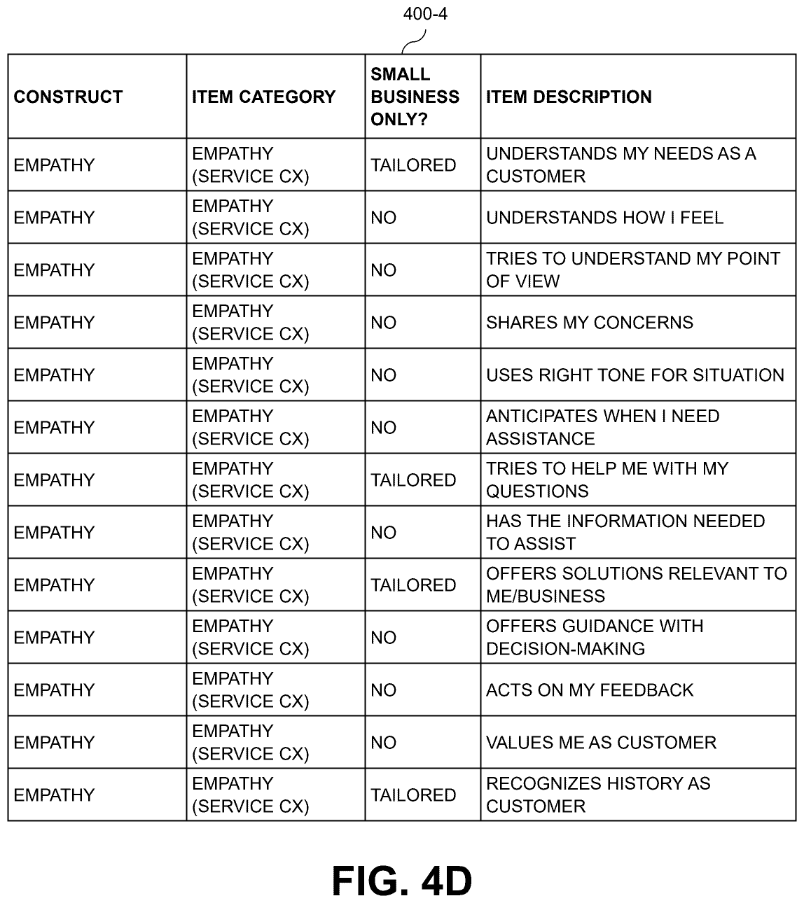

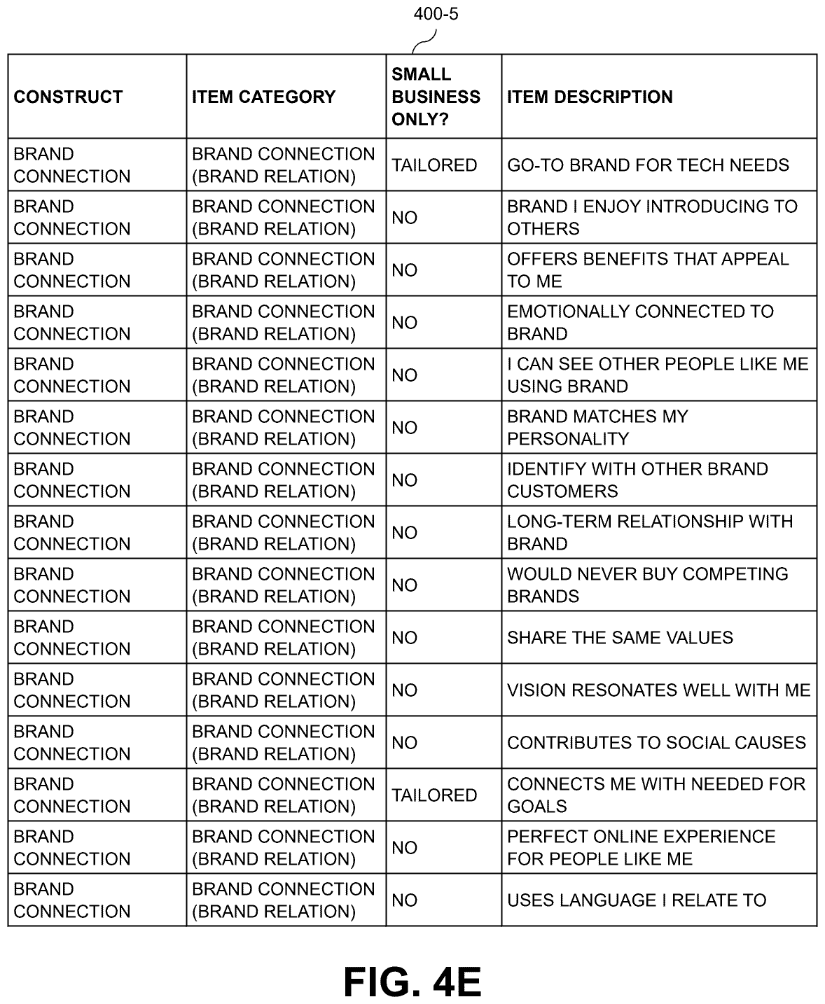

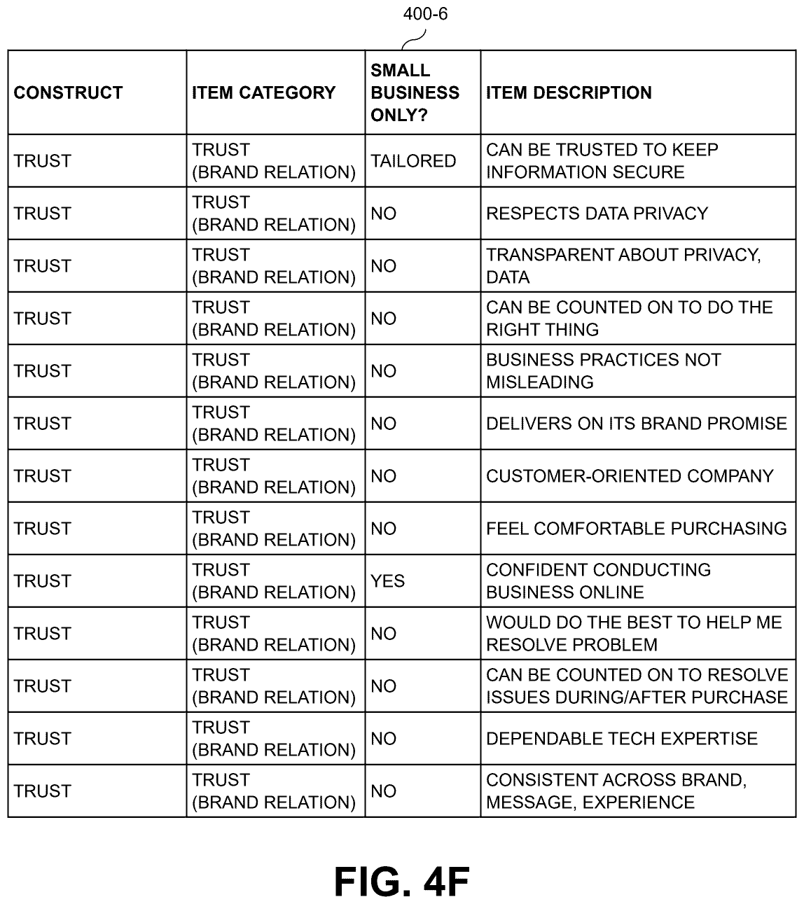

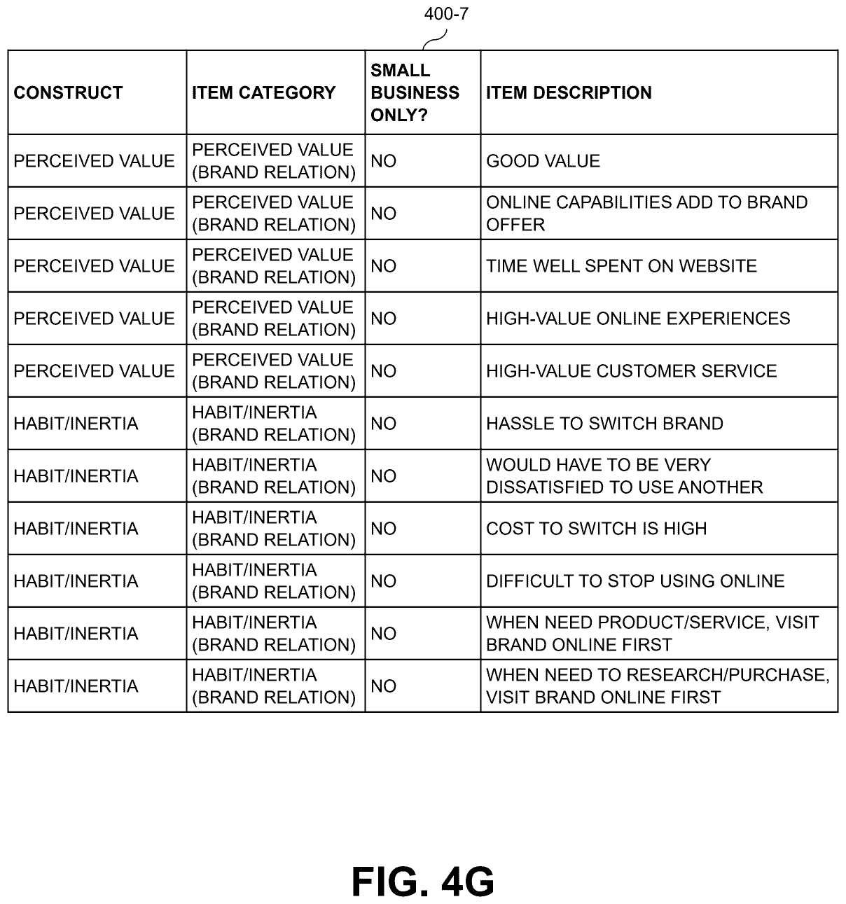

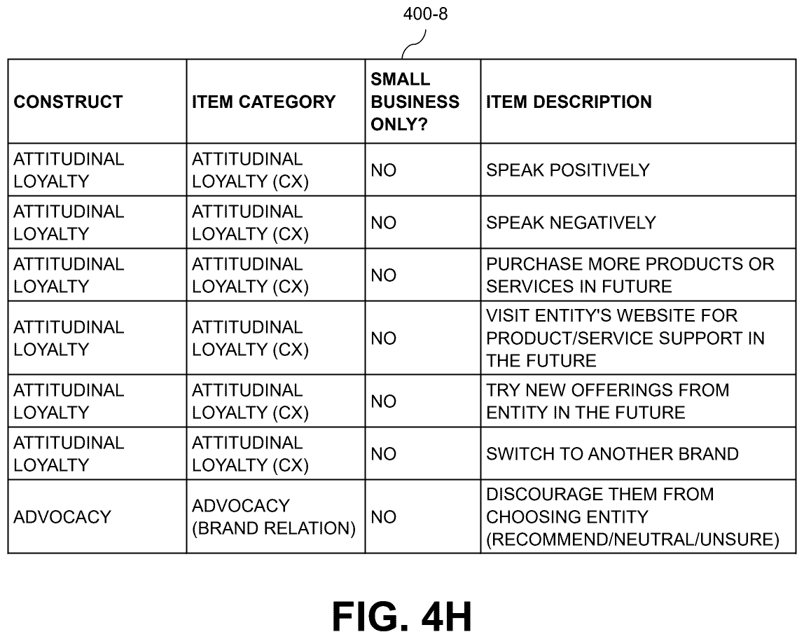

FIG. 3 shows a graph 300 of hypothesized relationships among constructs, represented as directional paths with arrows. The same bodies of evidence from academia and relevant e-commerce industry settings are consulted to inform the directionality of these relationships. In the graph 300, the ovals represent latent constructs that precede the outcome of interest, behavioral loyalty, formulated with directional arrows as in a Structural Equation Model (SEM). Assessment of each construct (or latent variable) is made possible through usage of observed items (e.g., survey items for the purposes of framework validation). For example, constructs 1 through 9 are shown having different directional arrows with one another, where the constructs 1 through 9 may be various latent constructs such as customization/personalization, empathy, agency/empowerment, design, ease & effectiveness, perceived value, quality, and sentiment, respectively. FIGS. 4A-4H show different portions 400-1 through 400-8 of a table illustrating items which may be surveyed for a complete model validation. The different portions 400-1 through 400-8 shown in FIGS. 4A-4H are collectively referred to as table 400. The table 400 includes columns for the construct (e.g., sentiment, online quality, design, ease/effort, personalization, agency/empowerment, empathy, brand connection, trust, perceived value, habit/inertia, attitudinal loyalty, advocacy) as well as the item category (e.g., relating to customer experience (CX), online CX, service CX, brand relation), whether that construct applies to small business users only (including whether that item may be tailored for small business users), and an item description. It should be noted that the particular constructs, item categories and item descriptions shown in the table 400 are presented by way of example only, and that various other constructs, item categories and item descriptions may be used in other embodiments.

In the graph 300, the constructs 6 through 9 are all assumed to have a relationship with a trust construct (e.g., trusted CX, trust in brand, etc.), which has a relationship with an attitudinal loyalty construct. A habit construct also has a relationship with the attitudinal loyalty construct. In the graph 300, construct 6 further has a relationship with a brand connection construct, with the attitudinal loyalty construct also having a relationship with the brand connection construct. Both the brand connection and the attitudinal loyalty constructs have a relationship with the outcome of interest, behavioral loyalty.

The model generated by the digital platform behavior analysis and prediction framework 110 is then validated. In some embodiments, RStudio's lavaan package is used for Confirmatory Factor Analysis (CFA) and Structural Equation Model (SEM) analysis. SEM is a linear model framework that models simultaneous regression equations with latent variables and is particularly suitable when one needs to investigate systems of relationships (e.g., versus a regression with a single outcome and set of predictors). Considering only those variables which have one or more single arrowed paths pointing towards them, each group can be considered as a separate equation (e.g., a regression equation). Therefore, simultaneously, it is possible to assess how well the items are explaining the latent construct they were thought to represent and the overall “model” for explanatory value of the variability in the data. Model outputs are standardized by the variance of the latent variable (e.g., ξ), and by the variance of the outcome (e.g., indicators x). This corresponds to the “std.all” option in lavaan, R. The degree of standardization is completely customizable even to the point of not using any form of standardized estimates.

CFA will now be described in further detail. Survey audiences are aligned to marketing and experience delivery, and surveys with select or complete user loyalty analysis and behavioral prediction framework items were fielded in different populations. CFA is used to verify the measurement quality of all latent constructs individually. CFA allows for the calculation of factor loadings for all indicators, a check on convergent validity, and a check toward discriminant validity, in which no two constructs are too highly correlated. In so doing, the observed variables (e.g., attitudinal and sentiment survey responses) are grouped together to create latent (e.g., unobserved) constructs or variables. Factor loadings are compared across survey populations and within constructs to lend evidence toward which items are most suitable for which audiences and should be taken forward in the user loyalty analysis and behavioral prediction framework. Individual factor loadings and Chronbach's alpha (α) are assessed for each item and construct, respectively, in each survey setting. The net deliverables from the CFA include novel proprietary measurements for behavioral loyalty antecedents. In some embodiments, a set of 10 such measurements are used: customization/personalization, design, ease & effectiveness, quality, empathy, agency/empowerment, perceived value, sentiment, trust, brand connectedness, and attitudinal loyalty.

A measurement model is then used to determine the model fit related to the latent portion of the model to identify the most prevalent instances of model misfit. The interrelationships and covariation among latent constructs are examined, and each latent factor is afforded a metric. Model fit statistics are then assessed under different conditions (e.g., when variables are dropped, and where paths are added or removed). In some embodiments, the model fit statistics are assessed via the lavaan package in R.

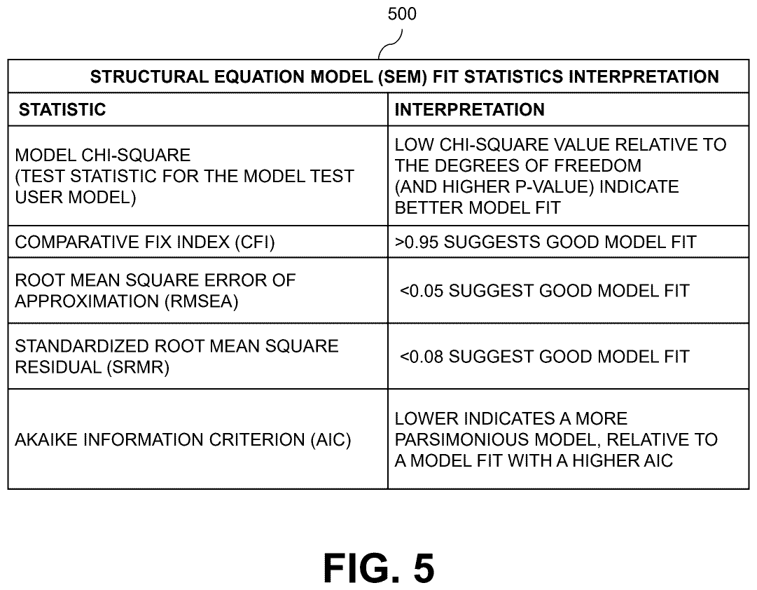

A structural model is then generated by combining predictive and measurement components in a display of interrelations among latent constructs and observable variables. Linkages among constructs and directionality of significant relationships are tested. The output is similar to a regression output, with standardized β coefficients, p-values and variances. Model fit is evaluated further at this phase and compared against previous iterations and with SEM fit guidelines. FIG. 5 shows a table 500 of model fit statistics interpretation for the SEM, showing different statistics such as the model Chi-Square, comparative fit index (CFI), root mean square error of approximation (RMSEA), standardized root mean square residual (SRMR) and Akaike information criterion (AIC). It should be noted that the list of model fit statistics shown in the table 500 is not exhaustive. Some embodiments may utilize additional statistics such as Bayesian information criterion (BIC), degrees of freedom (df), Tucker-Lewis index (TLI), etc. Model fit statistics for the overall model version, in some embodiments, are: Chi-Square=9361.771, df=3892; CFI=0.925; TLI=0.923; RMSEA=0.033; SRMR=0.033; AIC=289621.5; and BIC=290669.6, which are within the guidelines shown in the table 500 of FIG. 5.

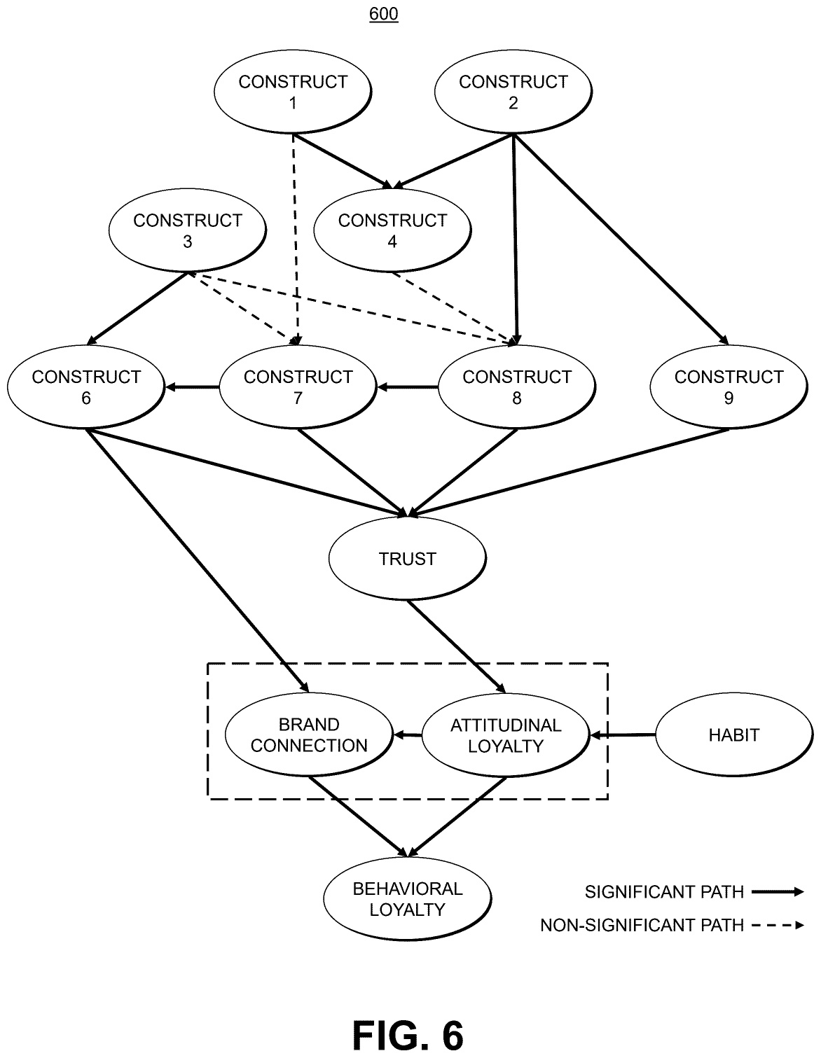

FIG. 6 shows a graph 600, which is validated version of the graph 300 showing different lines for significant and non-significant pathways among the constructs. The dashed lines indicate non-significant paths among the constructs (p<0.05), whereas the solid lines indicate significant pathways among constructs (p<0.05). Non-significant theoretical lines are maintained in the graph 600 for further assessment among users (e.g., online customers of an enterprise, organization or other entity's digital platform, such as a website or other online platform or interface), and for novel assessment among premier users online.

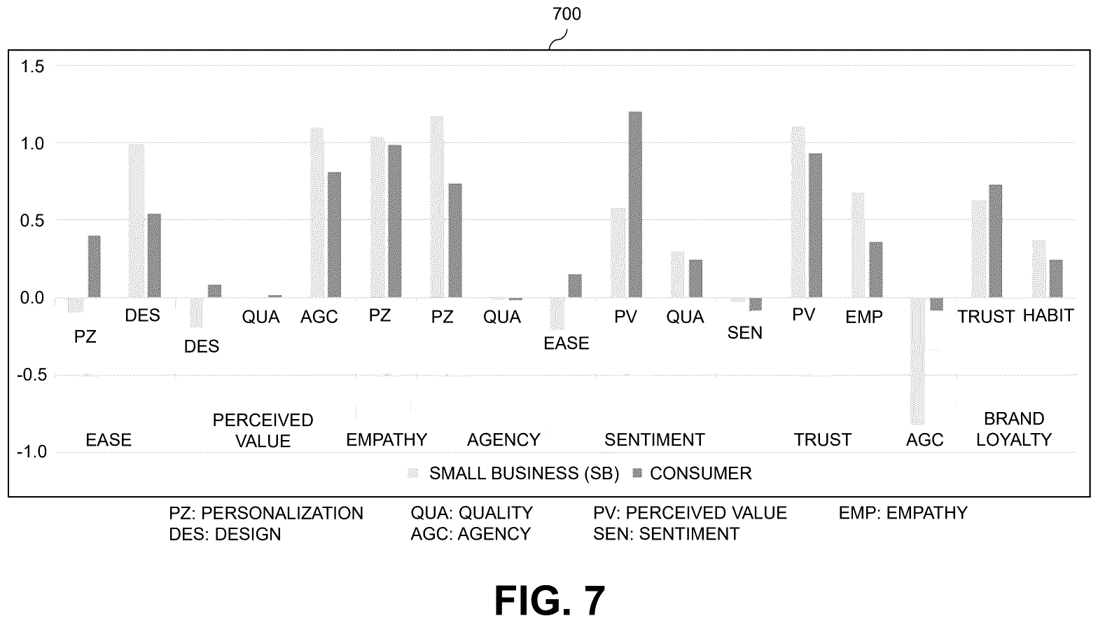

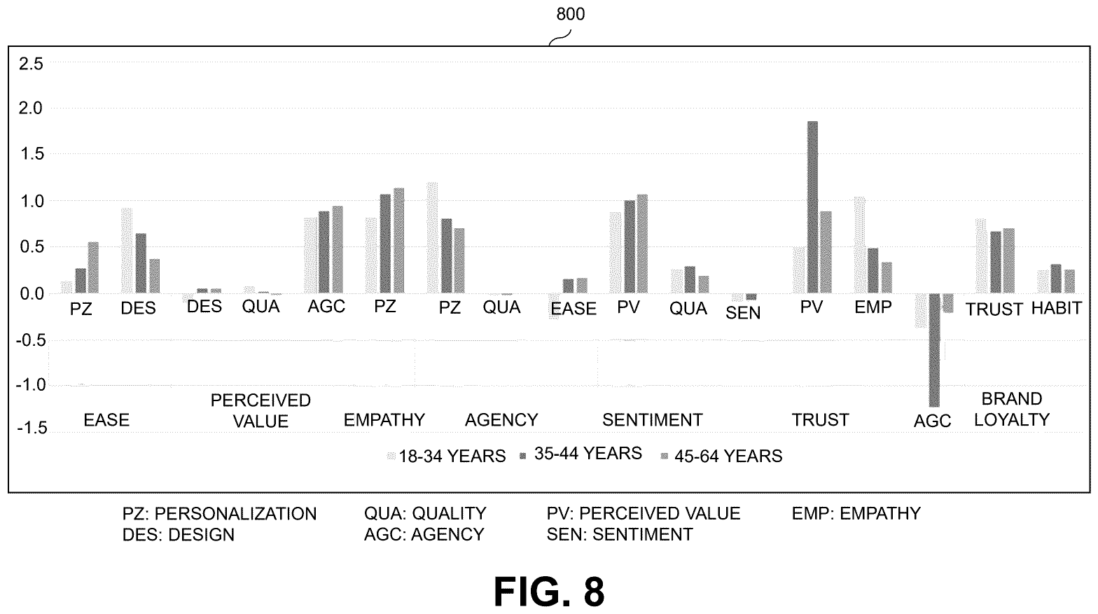

Model convergence and acceptable model fit are demonstrated at the total sample, small business and consumer levels separately. Since the psychological and cognitive antecedents of loyalty were theorized at the individual (e.g., human) level, and since acceptable model fit is demonstrated for both sub-populations separately using the same paths, the structural models were intentionally held constant for the small business and consumer levels. The intention is to maintain the structural model (e.g., as represented in the graph 600) and stratify by audience, as path significance between/among constructs can be appropriately evaluated for each sub-group. Further, β coefficients, which are interpreted as “for every one-unit increate in the [regressed variable], the [variable being regressed upon] increases or decreases by x units, controlling for the effects of the other constructs in the model,” can be compared among and across sub-groups. This is illustrated in the plot 700 of FIG. 7 and the plot 800 of FIG. 8. The plot 700 of FIG. 7 shows example output, comparing small business and consumer level SEM β coefficients by segment. The plot 800 of FIG. 8 shows example output, comparing SEM β coefficients for different age groups by segment. These comparisons are useful for prioritization of key drivers among specific sub-groups, and to identify areas of opportunity in which to invest or to steer resources toward or away. The quantification of and comparisons among latent constructs among key sub-groups is important to various stakeholders, including designers of a digital platform (e.g., a website or other online interface or platform), product, business and marketing teams, etc., enabling prioritization and actionable statistical takeaways.

Operationalization of the digital platform behavior analysis and prediction framework 110 will now be described. With confidence in validated constructs, the items used to measure the constructs, and the relationships between/among constructs, operationalization of the model generated by the digital platform behavior analysis and prediction framework 110 for real users of a digital platform operated by an enterprise, organization or other entity can begin. The process of operationalizing the loyalty measures includes the collection of explicit evaluations of loyalty drivers and the gradual substitution of those measures with implicit (e.g., observed) inputs—a process that benefits from continuous reevaluation and iteration as new items, interventions and measurement capabilities are introduced to the user experience.

Implementations of VoCaaS, micro-feedback in particular, may be effectively used within IT environments to field explicit indicators of the ease & effectiveness construct (e.g., via EOU questions) across user journeys. To operationalize the model generated by the digital platform behavior analysis and prediction framework 110, net-new implementations may be used to field surveys that can reach individual consumer and enterprise users across an enterprise, organization or other entity's platforms while in the digital experience. The same infrastructure and teams that support VoCaaS can provide the resources necessary to field and manage the new inputs for loyalty constructs. Explicit surveys will be linked to behavioral data (observed or implicit) for the same users via common identifiers, so both explicit and implicit inputs for the same individual can be attributed to the same user experience and analyzed simultaneously for convergent construct validity. Both implicit and explicit inputs can be consumed in the SEM in the same statistical process since both are manifest variables. Further, using implicit inputs reduces the burden on the participant to actively respond to survey items.

Advantageously, the items that are the result of the underlying loyalty constructs can be revisited at any time to re-validate their structural components. Not only are the relationships between and among the constructs quantifiable by audience, but also the constructs themselves serve as measures of experience (e.g., empathy and personalization constructs can be used as measures or indices individually for teams aiming to align product or design work to deliver these for users).

Conventional approaches for computation of user loyalty have traditionally fallen into two categories: (1) academic, where the focus is on validating and quantifying the relationships among latent psychological and cognitive drivers of an individual's loyal behavior; and (2) industry, where the focus is on identification of user profitability drivers for benchmarking, intervention and prediction. Academic studies are highly acute and generally statistically robust, but are limited to specific, usually irreproducible audiences (i.e., convenient population samples). Industry methods are intended for broad implementation but, as such, are largely inflexible methodologically and statistically. Conventional approaches for measuring user loyalty typically rely on self-reported measures of intention to buy (e.g., NPS) or self-reported measures of satisfaction with products or services. These measures, however, are simplistic in order to scale across countries, cultures, industries and time. That simplicity has led some to consider the measures inaccurate for their culture and/or user characteristics (e.g., NPS among Japanese consumers). As a response, companies either abandon or adapt these scales to better (and more statistically) fit their populations (e.g., adaptation of the European Customer Satisfcation Index (ECSI) with addition of a trust construct to predict tourist loyalty).

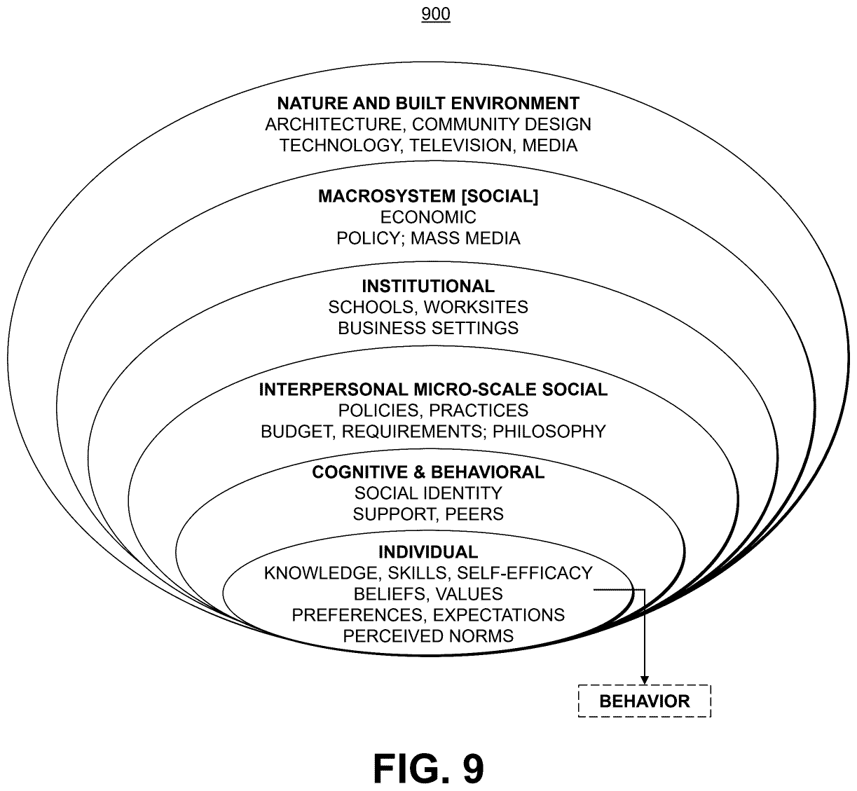

The technical solutions described herein provide various technical advantages which overcome these and other technical problems associated with conventional approaches. For example, the technical solutions described herein enable sensitivity and specificity for unique yet distinct users of a digital platform operated by a particular enterprise, organization or other entity. The digital platform behavior analysis and prediction framework 110 provides a holistic, quantifiable analytical tool for the systems of relationships that ultimately drive individual humans' decision-making and behavior. The constructs included in the digital platform behavior analysis and prediction framework 110 are common to individuals and were not selected based on a select demographic or industry segment, but rather on the innate psychological, cognitive and emotional drivers of complex decision-making. The socio-determinants that influence individual experience and behavior, such as country, industry type, global regulations, etc., can be layered statistically on top of one another, or serve as stratification variables of the individual drivers of loyalty (as illustrated in the chart 900 of FIG. 9) in a statistically sound and theoretically compatible manner. In this way, the SEM generated by the digital platform behavior analysis and prediction framework 110 can quantify the impact of innate human qualities' impact on behavior across an enterprise, organization or other entity's digital platforms and experiences while still allowing for stratified industry, segment, business, line of business, etc. estimations. FIG. 9 shows a chart 900 illustrating various socio-determinants of individual human behavior and decision-making. The nested determinants are organized inward to outward, with the micro-systems closest to the individual layer at the bottom and those furthest away from the individual at the top. Generally, for sustained behavior change to occur, multiple levels of intervention are needed. The more of these determinants that can be identified and quantified (e.g., understood), the better the understanding of human behavior and planning for sustained behavior change can be.

The technical solutions described herein also provide the flexibility to adapt to global, individual, market and e-commerce changes over time. Revisitation of the constructs and the items used to assess them can and should occur regularly (e.g., via CFA and other statistical exploration such as correlation or “drivers” analysis) to ensure acceptable model fit over time and to explore the model's explicability of the variability observed among variables. Model items (e.g., the observed items that are believed to occur as a consequence of the underlying latent construct) can be updated, removed or adapted as the digital experience of a digital platform changes and as global, market, e-commerce and/or individual expectations or perceptions change over time. Importantly, the items can be assessed individually for their impact on the construct and on the ecosystem as a whole to determine if they still contribute (e.g., load onto) the constructs. These changes to individual items can occur without eliminating a construct or vastly disrupting the overall theoretical model. Most impactfully, there is no dependence on an outside vendor for additional research, nor is there reliance on other companies or industries to accept the changes, or compliance to observe, as the digital platform behavior analysis and prediction framework 110 may be developed and completely managed “in-house” or internal to an enterprise, organization or other entity's own data, systems and users of a digital platform.

Additional technical advantages are provided through the technical solutions enabling scalable, automated prediction. The novel approach to quantifying user loyalty utilized in some embodiments provides an automatable method for estimating the impact of psychological, cognitive, emotional and transactional drivers of loyal behavior across an enterprise, organization or other entity's digital platforms, segments and users. For example, a customer sentiment team may field, manage, analyze and socialize CSAT survey data. The same or similar data capture, data engineering, data analysis and data visualization tools can be used to synthesize behavioral loyalty information. Further, the scalability extends beyond survey techniques in that automated observations can be used, once identified as suitable for substitution for or complementary to current explicit inputs (e.g., ease of use, purpose completion, etc.). The technical solutions therefore provide functionality that increases the generalization of user experiential measures beyond those individuals that are completing surveys to all of those for whom observable inputs are available. This unlocks the ability to provide insights for a much more representative sample of an enterprise, organization or other entity's users across more tasks, platforms and time. It also reduces the inevitable bias that even the best-conducted surveys introduce in general when prompting individuals for explicit feedback—in essence, asking them to verbalize their subconscious perceptions and, sometimes, offering them a list of finite choices to do so.

The technical solutions are also advantageously able to provide behavioral-based personalization. Each individual has a unique combination of innate and environmental determinants that impact their behavior and decision-making, whether on their own behalf or on behalf of the enterprise, organization or other entity for whom they are conducting business or other activity. The technical solutions allow for digital experiences on a digital platform to be broken down into their psychological, cognitive, emotional, and transactional components to understand each's impact on each individual's behavior. This is true individual behavioral-based personalization unlocked, which provides significant technical advantages for enabling human progress.

Indicators of user experience include CSAT, EOU and NPS. The various individual constructs which may be used within an SEM model generated by the digital platform behavior analysis and prediction framework 110 as described herein (e.g., design, personalization, ease & effectiveness, quality, empathy, agency/empowerment, perceived value, sentiment, trust, attitudinal loyalty, brand affinity, behavioral loyalty, etc.) act as measures (e.g., indices) in and of themselves that will prove immediately useful to teams orienting their goals, objectives and key performance indicators (KPIs) around delivering and measuring digital value for users, particularly beyond a single transaction. These can be trended over time and used in predictive analytics (e.g., machine learning for business and experiential outcomes).

Further, the relationships among constructs, as illustrated and quantified with the SEM or other model generated by the digital platform behavior analysis and prediction framework 110, can be used for causal analysis of experience delivery across an enterprise, organization or other entity's complex ecosystem of user experiences within a digital platform. This means that a deeper level of understanding of user expectations can be accomplished, enabling prioritization. For example, the impact of a single item used to assess a single construct can be followed throughout the model to understand how each indicator of experience impacts the system as a whole. Further, comparisons across groups (e.g., by age, business segment, region, task, industry, etc.) are possible, allowing for better prioritization of aspects of the experience to deliver when, where and for which audience.

Use of the technical solutions described herein advantageously allows an enterprise, organization or other entity to disassociate from the limitations of vendor-supplied frameworks and measures. The technical solutions described herein build capacity for data collection, aggregation, analysis, modeling, deep learning and prediction in-house. The technical solutions described herein also enable reduced costs (e.g., costs spent on vendor provision and vendor replacements), and unlock the ability to link additional valuable data available only on an enterprise, organization or other entity's users (e.g., hit level customer pagination and interaction metrics). Further, the technical solutions described herein are sustainable, maturable, scalable, adaptable and proprietary, yet also provide an individual-focused user-centric framework from which other enterprise, organizations or other entities with like interest in modeling user experience and long-term user loyalty would benefit. Still further, the digital platform behavior analysis and prediction framework 110 may include various extensions which are relatively unbounded, especially with the exponential growth of available user metadata.

Advantageously, the technical solutions described herein provide a novel approach for customized loyalty measurement which represents an opportunity for an enterprise, organization or other entity operating a digital platform to differentiate from competitors by better understanding how and for whom to tailor better, smarter experiences and designs of their digital platform, such as a website or other online interface. There is a competitive advantage in utilizing such a scalable method for predicting and facilitating repeat user transactions and usage of a digital platform).

Given the enormous amount of digital platform usage data that enterprises, organizations or other entities now have access to, there are numerous use cases for the technical solutions described herein. Conventional approaches that rely on unidimensional measures of user experience that purport to predict user loyalty or represent the user experience are not harnessing the complete power of real-world data available in real-time to estimate and predict user behavior. Quantifying the previously impossible-to-quantify and tying those individually calculated measurements to individual and account-level user profitability and usage metrics replaces the reliance on the expressed intention to buy with verifiable behavior on a digital platform. This level of accountability will drive better decision-making on behalf of an enterprise, organization or other entity aiming to provide the right experiences for the right users at the right time. It also facilitates prioritization of which constructs (e.g., drivers) matter most to which users. Further, steadily reducing the reliance on stated measures of experience with observed digital behaviors will serve enterprise, organizations and other entities well as they pivot into a cloud future, with more subscription offerings and as user expectations evolve beyond service delivery. The digital platform behavior analysis and prediction framework 110 provides and enables a user-centric mindset, allowing for rewarding users with experiential value, through tracking and understanding not only their financial purchases but also their online engagement with a digital platform (beyond login and transactions).

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for configuration of a digital platform based on modeled user behavior will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in

FIG. 1. The cloud infrastructure 1000 comprises multiple virtual machines (VMs) and/or container sets 1002-1, 1002-2, . . . 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, . . . 1010-L running on respective ones of the VMs/container sets 1002-1, 1002-2, . . . 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, . . . 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for configuration of a digital platform based on modeled user behavior as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to monitor interaction of a plurality of users with a digital platform;
to determine associations between the monitored interaction of the plurality of users with the digital platform and a set of constructs;
to generate a model of user behavior associated with the digital platform, the generated model specifying interrelationships of at least particular constructs in the set of constructs with one another and an output behavioral metric;
to predict, utilizing the generated model and the determined associations between the monitored interaction of the plurality of users and the set of constructs, effects of one or more modifications to a configuration of the digital platform on the output behavioral metric; and
to implement at least one of the one or more modifications to the configuration of the digital platform based at least in part on the predicted effects of the one or more modifications to the configuration of the digital platform on the output behavioral metric.

2. The apparatus of claim 1 wherein the digital platform comprises at least one of a website and a web-based interactive application operated by a given vendor of information technology assets.

3. The apparatus of claim 1 wherein the output behavioral metric characterizes behavioral loyalty to an entity operating the digital platform.

4. The apparatus of claim 1 wherein determining the associations between the monitored interaction of the plurality of users with the digital platform and the set of constructs comprises:
collecting a set of explicit evaluations of the set of constructs for at least a subset of the plurality of users; and
correlating (i) the monitored interaction of the subset of the plurality of users with the digital platform and (ii) the collected set of explicit evaluations of the set of constructs.

5. The apparatus of claim 1 wherein generating the model comprises:
utilizing Confirmatory Factor Analysis (CFA) to determine measurement quality of respective ones of a plurality of latent constructs for the output behavioral metric; and
selecting the set of constructs from the plurality of latent constructs based at least in part on the determined measurement quality.

6. The apparatus of claim 1 wherein generating the model comprises determining interrelationships and covariation among a plurality of latent constructs and the output behavioral metric.

7. The apparatus of claim 6 wherein generating the model further comprises evaluating model fit statistics associated with inclusion of respective ones of the plurality of latent constructs in the set of constructs of the generated model.

8. The apparatus of claim 6 wherein generating the model further comprises evaluating model fit statistics associated with inclusion and removal of paths between different ones of the plurality of latent constructs in the generated model.

9. The apparatus of claim 1 wherein generating the model comprises utilizing Structural Equation Models (SEM) to determine the interrelationships of at least particular constructs in the set of constructs with one another and the output behavioral metric.

10. The apparatus of claim 9 wherein determining the interrelationships of at least particular constructs in the set of latent constructs with one another and the output behavioral metric comprises testing linkages and directionality of paths interconnecting different ones of the constructs with one another and the output behavioral metric in a graph structure.

11. The apparatus of claim 1 wherein generating the model comprises generating two or more versions of the generated model associated with different subsets of the plurality of users, wherein a first one of the two or more versions of the generated model associated with a first subset of the plurality of users has a first set of weightings for the interrelationships of at least particular constructs in the set of constructs with one another and the output behavioral metric, and wherein a second one of the two or more versions of the generated model associated with a second subset of the plurality of users has a second set of weightings for the interrelationships of at least particular constructs in the set of constructs with one another and the output behavioral metric, the second set of weighting being different than the first set of weightings.

12. The apparatus of claim 11 wherein the first subset of the plurality of users and the second subset of the plurality of users are associated with at least one of different types of users and different age groups.

13. The apparatus of claim 11 wherein:
predicting the effects of the one or more modifications to the configuration of the digital platform on the output behavioral metric comprises: predicting a first set of effects of the one or more modifications to the configuration of the digital platform on the output behavioral metric for the first subset of the plurality of users utilizing the first version of the generated model; and predicting a second set of effects of the one or more modifications to the configuration of the digital platform on the output behavioral metric for the second subset of the plurality of users utilizing the second version of the generated model; and
implementing said at least one of the one or more modifications to the configuration of the digital platform comprises: implementing at least a first one of the one or more modifications to the configuration of the digital platform for the first subset of the plurality of users based at least in part on the predicted first set of effects; and implementing at least a second one of the one or more modifications to the configuration of the digital platform for the second subset of the plurality of users based at least in part on the predicted second set of effects.

14. The apparatus of claim 1 wherein the one or more modifications to the configuration of the digital platform comprises prioritizations of one or more aspects of a digital experience to deliver to different subsets of the plurality of users of the digital platform.

15. A computer program product comprising a non-transitory processor-readable storage medium having stored therein program code of one or more software programs, wherein the program code when executed by at least one processing device causes the at least one processing device:
to monitor interaction of a plurality of users with a digital platform;
to determine associations between the monitored interaction of the plurality of users with the digital platform and a set of constructs;
to generate a model of user behavior associated with the digital platform, the generated model specifying interrelationships of at least particular constructs in the set of constructs with one another and an output behavioral metric;
to predict, utilizing the generated model and the determined associations between the monitored interaction of the plurality of users and the set of constructs, effects of one or more modifications to a configuration of the digital platform on the output behavioral metric; and
to implement at least one of the one or more modifications to the configuration of the digital platform based at least in part on the predicted effects of the one or more modifications to the configuration of the digital platform on the output behavioral metric.

16. The computer program product of claim 15 wherein the digital platform comprises at least one of a website and a web-based interactive application operated by a given vendor of information technology assets.

17. The computer program product of claim 15 wherein the output behavioral metric characterizes behavioral loyalty to an entity operating the digital platform.

18. A method comprising:
monitoring interaction of a plurality of users with a digital platform;
determining associations between the monitored interaction of the plurality of users with the digital platform and a set of constructs;
generating a model of user behavior associated with the digital platform, the generated model specifying interrelationships of at least particular constructs in the set of constructs with one another and an output behavioral metric;
predicting, utilizing the generated model and the determined associations between the monitored interaction of the plurality of users and the set of constructs, effects of one or more modifications to a configuration of the digital platform on the output behavioral metric; and
implementing at least one of the one or more modifications to the configuration of the digital platform based at least in part on the predicted effects of the one or more modifications to the configuration of the digital platform on the output behavioral metric;
wherein the method is performed by at least one processing device comprising a processor coupled to a memory.

19. The method of claim 18 wherein the digital platform comprises at least one of a website and a web-based interactive application operated by a given vendor of information technology assets.

20. The method of claim 18 wherein the output behavioral metric characterizes behavioral loyalty to an entity operating the digital platform.
